(19) United States
(12) Patent Application Publication
(10) Pub. No.: US 2026/0056168 A1
(43) Pub. Date: Feb. 26, 2026

(54) AUTOSAMPLER

(71) Applicant: SHIMADZU CORPORATION, Kyoto (JP)

(72) Inventor: Hiroyuki MINATO, Kyoto (JP)

(73) Assignee: SHIMADZU CORPORATION, Kyoto (JP)

(21) Appl. No.: 19/277,476

(22) Filed: Jul. 23, 2025

(30) Foreign Application Priority Data
Aug. 23, 2024 (JP) 2024-141843

(51) Int. Cl. G01N 30/24; G01N 30/20; G01N 30/18

(52) U.S. Cl. CPC G01N 30/24; G01N 30/20; G01N 2030/185; G01N 2030/201; G01N 2030/207

(57) ABSTRACT

An autosampler comprises a needle unit having a needle holding part that holds a needle for aspirating and discharging fluid through a tip thereof, the needle unit moving the needle holding part in a vertical direction while moving in a horizontal direction; an injection port having therein a flow path to which the needle is fluidly connected during sample injection, wherein an opening communicating with the flow path is provided on an upper surface, a seal part is provided inside the opening, against which an outer peripheral surface of the tip of the needle is pressed when the needle descends to a predetermined height from above the opening, and the tip of the needle being pressed against the seal part causes the needle to be fluidly connected in a liquid-tight manner to the flow path; and a magnetic force part provided to apply a magnetic force in a direction that pushes down the needle holding part, at least in a state where the outer peripheral surface of the needle is pressed against the seal part in the injection port.

### TECHNICAL FIELD

The present invention relates to an autosampler used in a chromatograph such as a liquid chromatograph, a supercritical fluid chromatograph, or an ion chromatograph.

### BACKGROUND ART

In an autosampler for a liquid chromatograph, a supercritical fluid chromatograph, or an ion chromatograph, an injection port is fluidly connected to one port of an injection valve. During sample injection, the tip of a needle that has aspirated a sample from a sample container is inserted into the injection port to fluidly connect the needle to the injection port (see Patent Literature 1).

### [Citation List]

### [Patent Literature]

### [Patent Literature I] International Publication NO. WO 2020/121430

### SUMMARY OF INVENTION

### [Problem to be Solved by the Invention]

A seal part is provided inside the opening on the upper surface of the injection port. When fluidly connecting the needle to the injection port, the tip of the needle is pressed against the seal part by inserting the needle into the injection port, thereby ensuring the sealability of the connection between the needle and the injection port. The pressing of the tip of the needle against the seal part while the needle is fluidly connected to the injection port is maintained by continuously driving a motor that moves the needle up and down to push the needle downward. Therefore, it is necessary to continuously supply power to the motor that moves the needle up and down even while the needle is fluidly connected to the injection port and its movement is stopped. If the power supply to the motor is interrupted, such as by the main power of the autosampler being accidentally turned off while the needle is fluidly connected to the injection port, the pressing force of the needle tip against the seal part is lost. As a result, the sealability between the needle and the injection port is lost, and there is a risk of liquid leaking from the needle.

Incidentally, as mechanisms for moving the needle up and down, there are a ball bearing system and a belt-pulley system. The belt-pulley system has the advantage of being able to move the needle up and down at a higher speed compared to the ball bearing system. On the other hand, in the belt-pulley system, compared to the ball bearing system, forces other than the driving force of the motor are less likely to act on the needle. If the power supply to the motor is lost while the needle is fluidly connected to the injection port, the needle is more likely to be pushed upward by the pressure of the fluid in the flow path or the repulsive force of the seal part of the injection port, leading to the aforementioned liquid leakage.

The present invention has been made in view of the above problem, and an object thereof is to ensure the sealability between the injection port and the needle even without continuously supplying power to the motor that moves the needle up and down, in a state where the tip of the needle is pressed against the seal part in the injection port.

### [Means for Solving the Problem]

An autosampler according to the present invention is an autosampler that performs sample injection into a mobile phase flowing toward a separation column in a chromatograph, the autosampler comprising: a needle unit having a needle holding part that holds a needle for aspirating and discharging fluid through a tip thereof, the needle unit moving the needle holding part in a vertical direction while moving in a horizontal direction; an injection port having therein a flow path to which the needle is fluidly connected during the sample injection, wherein an opening communicating with the flow path is provided on an upper surface, a seal part is provided inside the opening, against which an outer peripheral surface of the tip of the needle is pressed when the needle descends to a predetermined height from above the opening, and the needle is configured to be fluidly connected in a liquid-tight manner to the flow path by the tip of the needle being pressed against the seal part; and a magnetic force part provided to apply a magnetic force in a direction that pushes down the needle holding part, at least in a state where the outer peripheral surface of the needle is pressed against the seal part in the injection port.

### [Advantageous Effects of Invention]

The autosampler according to the present invention includes the magnetic force part provided to apply a magnetic force in a direction that pushes down the needle holding part in a state where the outer peripheral surface of the needle is pressed against the seal part in the injection port. Therefore, the sealability between the injection port and the needle is ensured even without continuously supplying power to the motor that moves the needle up and down, in a state where the tip of the needle is pressed against the seal part in the injection port.

### BRIEF DESCRIPTION OF DRAWINGS

FIG. 1 is a schematic configuration diagram showing an embodiment of an autosampler.

FIG. 2 is a diagram showing an example of the configuration of a magnetic force part, showing a state before the tip of the needle is inserted into the injection port.

FIG. 3 is a diagram showing an example of the configuration of the magnetic force part, showing a state when the tip of the needle is being inserted into the injection port.

FIG. 4 is a diagram showing another example of the configuration of the magnetic force part.

### DESCRIPTION OF EMBODIMENTS

Hereinafter, an embodiment of an autosampler according to the present invention will be described with reference to the drawings. Hereinafter, an autosampler used in a liquid chromatograph will be described as an example, but the present invention can be similarly applied to autosamplers used in supercritical fluid chromatographs and ion chromatographs.

The autosampler 2 includes a needle unit 3, a sample loop 6, an injection valve 8, a syringe pump 10, an injection port 12, a magnetic force part 17, and a controller 18.

The needle unit 3 includes a needle holding part 5 that holds a needle 4, and moves the needle 4 three-dimensionally by moving the needle holding part 5 in a vertical direction while the unit itself moves in a horizontal direction. The needle 4 has a tip and a base end and is for aspirating a sample from the tip. The needle holding part 5 holds the needle 4 with the tip of the needle 4 directed vertically downward.

One end of a sample loop 6 is fluidly connected to the base end of the needle 4. The sample loop 6 is a flow path for holding the sample aspirated from the tip of the needle 4, and the other end opposite to the needle 4 is fluidly connected to one port (1) of the injection valve 8.

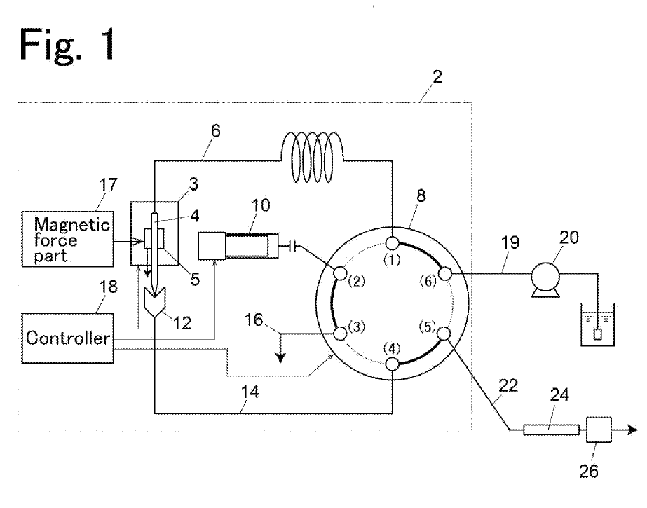

The injection valve 8 is for switching the flow path configuration, and in this embodiment, a 6-port valve is used. In addition to the sample loop 6, a syringe pump 10, a pipe 14 communicating with the injection port 12, a drain flow path 16, a mobile phase supply flow path 19, and an analysis flow path 22 are connected to each port of the injection valve 8. The mobile phase supply flow path 19 is a flow path for supplying a mobile phase by a liquid sending pump 20. The analysis flow path 22 is a flow path in which a separation column 24 and a detector 26 are provided. The injection valve 8 can be switched between one of a sampling state (a state where port (1) and (2) are connected, port (3) and (4) are connected, and port (5) and (6) are connected) in which the mobile phase supply flow path 19 and the analysis flow path 22 are directly connected and the syringe pump 10 is connected to the needle 4 via the sample loop 6, and an injection state (the state of FIG. 1 where port (1) and (6) are connected, port (2) and (3) are connected, and port (4) and (5) are connected) for interposing the sample loop 6 and the needle 4 between the mobile phase supply flow path 19 and the analysis flow path 22.

The syringe pump 10 is provided so as to be fluidly connected to the needle 4 via the sample loop 6 by the injection valve 8, and is for performing sample aspiration via the needle 4. When aspirating a sample from a sample container by the needle 4, the injection valve 8 is set to the sampling state, and the syringe pump 10 is connected to the needle 4 via the sample loop 6.

The injection port 12 is fluidly connected to one port (4) of the injection valve 8 via the pipe 14, and is for guiding the sample aspirated from the tip of the needle 4 and held in the sample loop 6 to the analysis flow path 22. When injecting the sample aspirated from the tip of the needle 4, as shown in the state of FIG. 1, the tip of the needle 4 is inserted into the injection port 12, and the injection valve 8 is set to the injection state. As a result, the sample held in the sample loop 6 is guided to the analysis flow path 22 by the mobile phase supplied through the mobile phase supply flow path 19.

The magnetic force part 17 is a mechanism provided to apply a magnetic force in a downwardly pushing direction to the needle holding part 5, at least in a state where the tip of the needle 4 is inserted into the injection port 12.

The controller 18 controls the operations of the needle unit 3, the injection valve 8, and the syringe pump 10. The controller 18 can be realized by an electronic circuit including a CPU (Central Processing Unit) and the like.

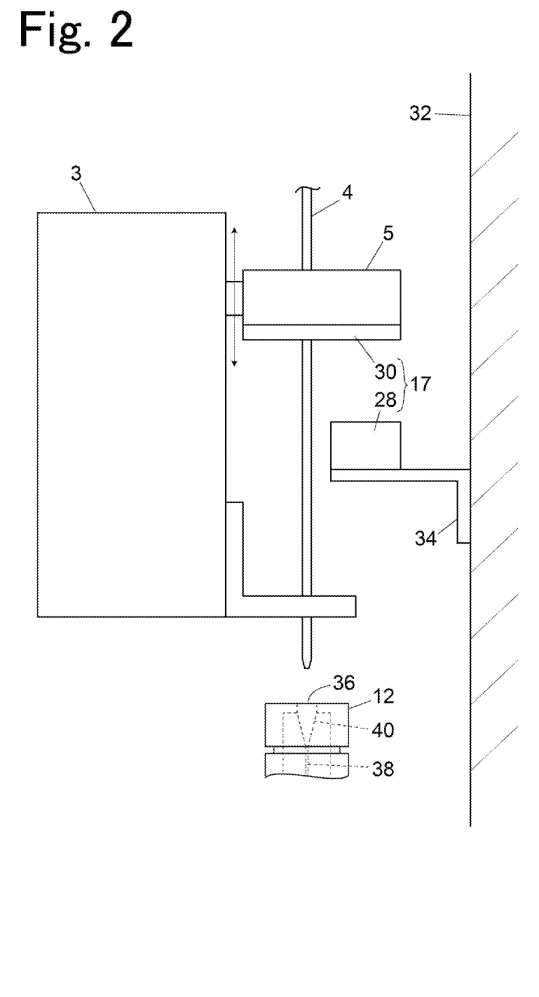

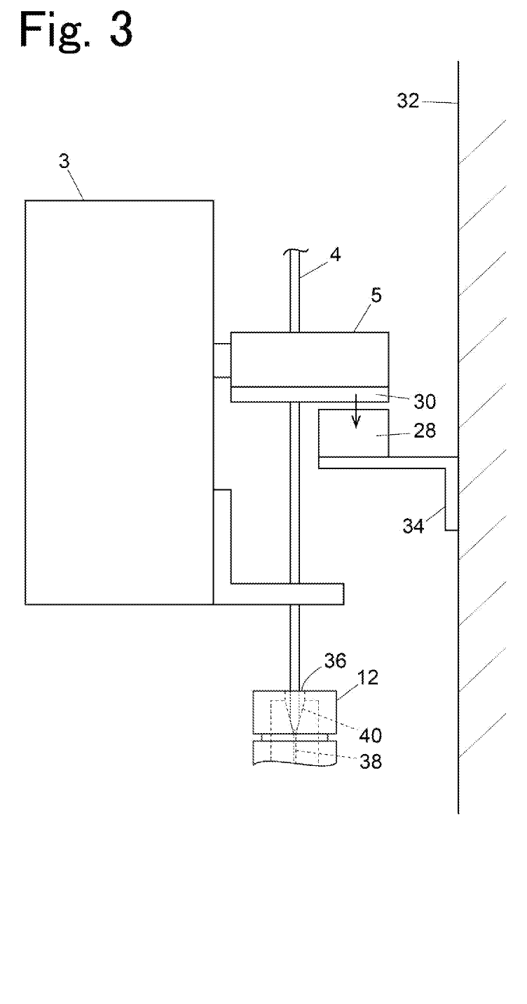

An example of the configuration of the magnetic force part 17 will be described with reference to FIG. 2 and FIG. 3.

First, the injection port 12 will be described. The injection port 12 has a flow path 38 therein for fluidly connecting the needle 4 during sample injection, and has an opening 36 on its upper surface that communicates with the flow path 38. The flow path 38 communicates with the pipe 14. Inside the opening 36, a tapered seal part 40 is provided, whose inner surface is inclined such that its inner diameter decreases downward.

As shown in FIG. 3, when the needle 4 is fluidly connected to the injection port 12, the needle holding part 5 descends to a predetermined height with the needle 4 positioned directly above the opening 36 of the injection port 12, whereby the outer peripheral surface of the tip of the needle 4 is pressed against the inner peripheral surface of the seal part 40. By pressing the outer peripheral surface of the tip of the needle 4 against the inner peripheral surface of the seal part 40, the needle 4 and the flow path 38 are fluidly connected in a liquid-tight manner.

The magnetic force part 17 is a mechanism that assists in pressing the tip of the needle 4 against the seal part 40 when fluidly connecting the needle 4 to the injection port 12, and can include a magnet 28 and a metallic member 30. In this example, the magnet 28 is fixed to a housing 32 of the autosampler 2 via a mounting member 34, and the metallic member 30 is attached to the needle holding part 5 of the needle unit 3 and moves up and down together with the needle holding part 5.

The magnet 28 is provided to be positioned below the metallic member 30 attached to the needle holding part 5, in a state where the needle 4 is directly above the opening 36 of the injection port 12. The height of the magnet 28 is designed such that, as shown in FIG. 3, when the needle holding part 5 descends to a predetermined height where the tip of the needle 4 is pressed against the seal part 40 in the injection port 12, the metallic plate 30 approaches the magnet 28 to a distance where the magnetic force of the magnet 28 sufficiently acts on the metallic plate 30.

With the above configuration, when the needle holding part 5 descends to the predetermined height where the tip of the needle 4 is pressed against the seal part 40 in the injection port 12, the metallic member 30 is attracted to the magnet 28 by the magnetic force of the magnet 28, whereby a downward pressing force acts on the needle holding part 5. As a result, even if power is not supplied to a motor (not shown) that moves the needle holding part 5 up and down, the force for pressing the tip of the needle 4 against the seal part 40 is ensured, and the sealability between the needle 4 and the flow path 38 is ensured. Conversely, by providing the magnetic force part 17, it is possible to stop the supply of power to the motor that moves the needle holding part 5 up and down while the needle 4 is fluidly connected to the injection port 12, thereby enabling power saving. That is, the controller 18 controlling the operation of the needle unit 5 can be configured to stop the supply of power to the motor that moves the needle holding part 5 up and down while the needle 4 is fluidly connected to the injection port 12.

Note that, although the height of the magnet 28 may be designed such that the metallic plate 30 comes into contact with the magnet 28 when the needle holding part 5 descends to the predetermined height, it is more preferable that the height is designed such that a slight gap (for example, 0.1 to 5 mm) exists between the magnet 28 and the metallic plate 30 when the needle holding part 5 descends to the predetermined height. By doing so, the contact noise between the magnet 28 and the metallic plate 30 when fluidly connecting the needle 4 to the injection port 12 is eliminated, thereby preventing noise caused by the magnetic force part 17, and also preventing failures due to the impact of contact between the magnet 28 and the metallic plate 30.

Further, in the above example, the magnet 28 is provided independently of the needle unit 3, and the metallic member 30 is provided on the needle unit 3 and interlocked with the vertical movement of the needle holding part 5. Conversely, the magnet 28 may be provided on the needle unit 3 and interlocked with the vertical movement of the needle holding part 5, and the metallic member 30 may be provided independently of the needle unit 3.

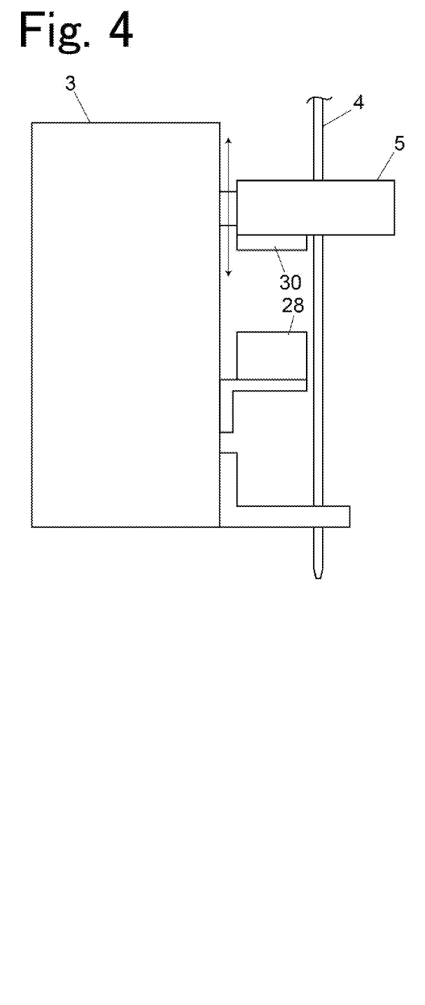

Further, in the above example, one of the magnet 28 and the metallic member 30 of the magnetic force part 17 is provided independently of the needle unit 3, and the other is provided on the needle unit 3. However, as long as it does not obstruct the access of the needle 4 to the sample container or the like, it is also possible to provide both the magnet 28 and the metallic member 30 on the needle unit 3, as shown in the example of FIG. 4. In the example of FIG. 4, the metallic member 30 is attached to the needle holding part 5, and the magnet 28 is independent of the needle holding part 5. However, the magnet 28 may be attached to the needle holding part 5, and the metallic member 30 may be independent of the needle holding part 5.

The embodiment described above is merely an illustration of an embodiment of the autosampler according to the present invention. An embodiment of the autosampler according to the present invention is as follows.

One embodiment of the autosampler according to the present invention is an autosampler that performs sample injection into a mobile phase flowing toward a separation column in a chromatograph, the autosampler comprising: a needle unit having a needle holding part that holds a needle for aspirating and discharging fluid through a tip thereof, the needle unit moving the needle holding part in a vertical direction while moving in a horizontal direction; an injection port having therein a flow path to which the needle is fluidly connected during the sample injection, wherein an opening communicating with the flow path is provided on an upper surface, a seal part is provided inside the opening, against which an outer peripheral surface of the tip of the needle is pressed when the needle descends to a predetermined height from above the opening, and the needle is configured to be fluidly connected in a liquid-tight manner to the flow path by the tip of the needle being pressed against the seal part; and a magnetic force part provided to apply a magnetic force in a direction that pushes down the needle holding part, at least in a state where the outer peripheral surface of the needle is pressed against the seal part in the injection port.

In a first aspect of the one embodiment, the magnetic force part includes a magnet and a metallic member provided to face each other vertically when the needle is at a position directly above the injection port, one of the magnet and the metallic member is provided to move in the vertical direction in conjunction with the needle holding part, the other of the magnet and the metallic member is provided to be fixed at the same height independently of the operation of the needle holding part, and when the tip of the needle is pressed against the seal part, the magnet and the metallic member are attracted to each other by the magnetic force of the magnet.

In the first aspect, the magnet and the metallic member may be provided to be in proximity with a gap therebetween when the tip of the needle is pressed against the seal part. By doing so, the contact noise between the magnet and the metallic plate when fluidly connecting the needle to the injection port is eliminated, thereby preventing noise caused by the magnetic force part, and also preventing failures due to the impact of contact between the magnet and the metallic plate.

Further, in the first aspect, the one of the magnet and the metallic member may be provided on the needle unit, and the other of the magnet and the metallic member may be provided independently of the needle unit.

Further, in the first aspect, both the magnet and the metallic member may be provided on the needle unit.

In a second aspect of the one embodiment, the autosampler further comprises a controller that controls the operation of the needle unit, the needle unit includes a motor for moving the needle holding part in the vertical direction, and the controller is configured to stop power supply to the motor in a state where the tip of the needle is pressed against the seal part of the injection port. This second aspect can be combined with the first aspect.

### REFERENCE SIGNS LIST

2 Autosampler

3 Needle unit

4 Needle

5 Needle holding part

6 Sample loop

8 Injection valve

10 Syringe pump

12 Injection port

17 Magnetic force part

18 Controller

19 Mobile phase supply flow path

20 Liquid sending pump

22 Analysis flow path

24 Separation column

26 Detector

28 Magnet

30 Metallic member

32 Housing

34 Mounting member

36 Opening of injection port

38 Flow path

40 Seal part

1. An autosampler for performing sample injection into a mobile phase flowing toward a separation column in a chromatograph, the autosampler comprising:
a needle unit having a needle holding part that holds a needle for aspirating and discharging fluid through a tip thereof, the needle unit moving the needle holding part in a vertical direction while moving in a horizontal direction;
an injection port having therein a flow path to which the needle is fluidly connected during the sample injection, wherein an opening communicating with the flow path is provided on an upper surface, a seal part is provided inside the opening, against which an outer peripheral surface of the tip of the needle is pressed when the needle descends to a predetermined height from above the opening, and the needle is configured to be fluidly connected in a liquid-tight manner to the flow path by the tip of the needle being pressed against the seal part; and
a magnetic force part provided to apply a magnetic force in a direction that pushes down the needle holding part, at least in a state where the outer peripheral surface of the needle is pressed against the seal part in the injection port.

2. The autosampler according to claim 1, wherein the magnetic force part includes a magnet and a metallic member provided to face each other vertically when the needle is at a position directly above the injection port,
one of the magnet and the metallic member is provided to move in the vertical direction in conjunction with the needle holding part, and the other of the magnet and the metallic member is provided to be fixed at the same height independently of the operation of the needle holding part, and
when the tip of the needle is pressed against the seal part, the magnet and the metallic member are attracted to each other by a magnetic force of the magnet.

3. The autosampler according to claim 2, wherein the magnet and the metallic member are provided to be in proximity with a gap therebetween when the tip of the needle is pressed against the seal part.

4. The autosampler according to claim 2, wherein the one of the magnet and the metallic member is provided on the needle unit, and the other of the magnet and the metallic member is provided independently of the needle unit.

5. The autosampler according to claim 2, wherein both the magnet and the metallic member are provided on the needle unit.

6. The autosampler according to claim 1, further comprising a controller that controls an operation of the needle unit,
wherein the needle unit includes a motor for moving the needle holding part in the vertical direction, and
the controller is configured to stop power supply to the motor in a state where the tip of the needle is pressed against the seal part of the injection port.
